(19) United States
(12) Patent Application Publication
(10) Pub. No.: US 2009/0237236 A1
(43) Pub. Date: Sep. 24, 2009

(54) TOOTH LOCATED GPS PERSON TRACKING AND LOCATION METHOD AND APPARATUS

(76) Inventor: Sami Maassarani, Troy, MI (US)

Correspondence Address: YOUNG BASILE, 3001 WEST BIG BEAVER ROAD, SUITE 624, TROY, MI, 48084, US

(21) Appl. No.: 12/053,681

(22) Filed: Mar. 24, 2008

(51) Int. Cl. H04Q 7/00

(52) U.S. Cl. 340/539.13; 433/229

(57) ABSTRACT

An apparatus and method for remotely and monitoring the location of a person through a microchip mounted in a tooth of a person which communicates by a communication link to a Global Positioning System to obtain geographic location information relating to the physical location of a person, and by another communication link to a remote tracking device to obtain the geographic information to determine and provide an indication of the physical location of a person. The microchip is disposed in a cavity formed in a tooth of a person which is filled with dental filling material to fix the microchip in the tooth.

### BACKGROUND

Tracking devices, such as radio frequency identification tags (RFID), are increasingly used to mark shipping pallets, library books and retail store items to provide a convenient means of determining the location and/or tracking the movement of the article on which the tag is mounted.

Such RFID tags or microchips are also increasingly used to provide identification and location information for pets, such as dogs and cats. In such applications, the tags are embedded in the pet by a surgical procedure.

RFID tags have also been used for monitoring the physical location of a person, especially children. The tags are applied to the person's body by typically mounting the tag in an article of clothing worn by the person, or on the person's glasses, a bracelet, a clip, or the shoes worn by the person.

However, the use of surgical procedures to embed a RFID tag or microchip in a pet, or even a person, is an invasive procedure subject to the normal dangers of surgery, such as infection, cost, etc. However, embedding the microchip or tag in the body of a pet or person assures that the tag cannot be easily separated from the pet or person.

Placing tags on an article of clothing, jewelry, etc. worn by a person are subject to loss or separation thereby rendering the monitoring and tracking function of such tags useless.

It would be desirable to provide a method and apparatus for tracking the physical location of a person which securely affixes a microchip or tag to the person in a secure, not easily removable manner while at the same time avoiding costly elective surgical procedures used to embed such microchips or tags in the body of a pet or person.

### SUMMARY

A method for remotely monitoring the location of a person comprising the steps of:

preparing a cavity in a tooth of a person;

mounting a microchip in the cavity, the microchip including a transceiver

means for transmitting a wireless signal containing geographic location information relating to the physical location of the person, the microchip adapted for communicating with a Global Positioning System to receive geographic location information of the person;

filling the cavity with a dental filling material;

establishing communication between the microchip by a first communication link and a tracking apparatus which wirelessly communicates with the microchip to obtain the geographic location information from the microchip to determine the geographic location of the person; and

establishing communication between the microchip by a second communication link between the microchip and the Global Positioning System for obtaining geographic information relating to the physical location of the person.

Other applications of the present invention will become apparent to those skilled in the art when the following description of the best mode contemplated for practicing the invention is read in conjunction with the accompanying drawings.

A system for remotely monitoring the location of a person comprising:

a microchip including a transceiver for transmitting a wireless signal containing geographic information relating to the physical location of a person, the microchip adapted to be mounted in a tooth of a person;

a Global Positioning System transmitting global positioning data to the microchip; and

a tracking apparatus disposed of a wireless communication with a microchip to obtain the geographic information from the microchip to determine the physical location of the person.

### BRIEF DESCRIPTION OF THE DRAWING

The various features, advantages and other uses of the present invention will become more apparent by referring to the following detailed description and drawing in which:

FIG. 1 is a pictorial representation of a person physical location tracking system;

FIG. 2 is a block diagram of the major elements of the tag shown in FIG. 1; and

FIG. 3 is an enlarged, cross-sectional view of a human tooth showing different mounting locations for the tag.

### DETAILED DESCRIPTION

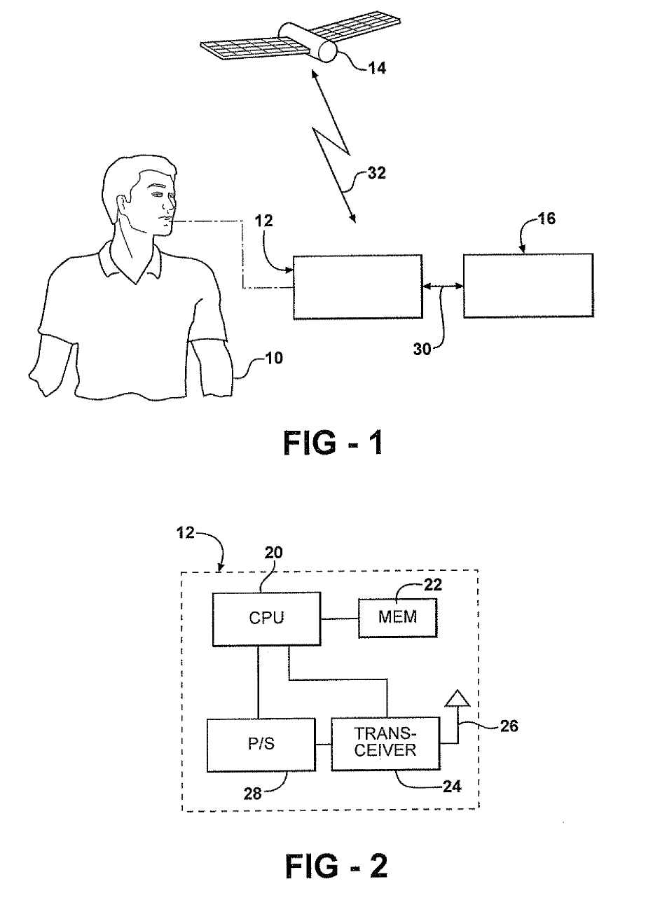

Referring now to the drawing, in FIGS. 1-3 in particular, there is depicted a system for remotely monitoring the physical location of a person 10. The system includes a tag or microchip 12, a Global Positioning System (GPS) 14, and a tracking device 16.

The GPS system 14 includes a plurality of satellites with only one satellite being shown by reference number 14 for clarity, which transmit global positioning data to the tag 12. The OPS data from one or more satellites 14 is used by the tag 12 to determine the physical location of the tag 12, which is mounted on the person 10, as described hereafter.

The tag 12 can be a radio-frequency identification (RFID) tag or microchip which includes components and software to collect the GPS data from the GPS system 14 to determine the geographic physical location of the person 10 on the earth.

As shown by way of example only in FIG. 2, the tag 12 may include a processor or CPU 20 which communicates with a memory 22 containing the control software executed by the processor 20 as well as the current geographic location information obtained from the GPS system or satellite 14.

A transceiver 24, which may be replaced by a separate transmitter and a separate receiver, is coupled to the CPU or processor 20 for communicating signals to and from the processor 20 via an antenna 26. A power supply 28 is coupled to the CPU 20 and the transceiver 24 for supplying electric power to the components to the tag 12. The power supply 28 may be an active power supply, such as a battery which can be recharged by energy sources internal to the body of the person 10, such as acoustic, mechanical, chemical, electrical, electromagnetic, or thermal sources derived from, for example, bodily temperature differences, muscle activity, vibrations due to pulse, speaking, breathing, etc. The power supply 28 may also be an inactive power supply, such as an inductive type power supply which induces electrical energy from signals received from the tracking unit 16.

The tracking unit 16 may be a suitable ground located tracking device, such as a mobile telephone network, radio communications array, etc. The tracking unit 16 may include a processor or be coupled to a separate processor.

The tracking unit 16 transmits wireless signals by a communication network or link 30, which can be an existing mobile telephone or radio communication network, to the tag 12. The signal or signals from the tracking unit 16 are transmitted over the link 30 which may include wireless portions, such as satellite uplinks, radio frequency communication, the Internet, etc., as well as hardline portions, including communication cables, telephone conductors, etc.

The signals from the tracking unit 16 are received by the processor 20 of the tag 12 and decoded. The CPU 20 is uniquely encoded to each person 10 so that a single tracking unit 16 may be employed to track a plurality of discrete people 10 where the tag 12 on each person 10 has a unique identification code. The CPU 20 of the tag 12 decodes the code portion of the signal received by the transceiver 24 from the tracking unit 16. When a code match is determined, the CPU 20 retransmits the geographic location information relating to the then physical location of the person 10 by the transceiver 24 and the antenna 26 through the communication link 30 to the tracking unit 16. This information is decoded by the tracking unit 16 and displayed in a convenient manner to enable the physical location of the person 10 to be visibly and/or audibly determined.

When activated by a signal received by the tracking unit 16 or on a separate recurring periodic basis, the processor or CPU 20 of the tag 12 communicates with the GPS system 14 via another communication network or link 32. The communication link 32 typically comprises a wireless satellite communication network which may include communication through mobile telephone or satellite towers and ground stations to and from the GPS satellites 14. The CPU 20 receives the GPS data from the satellite 14 through the transceiver 26, determines the geographic location of the person 10, and then transmits the geographic location information along with the person ID via the communication link 30 to the tracking unit 16.

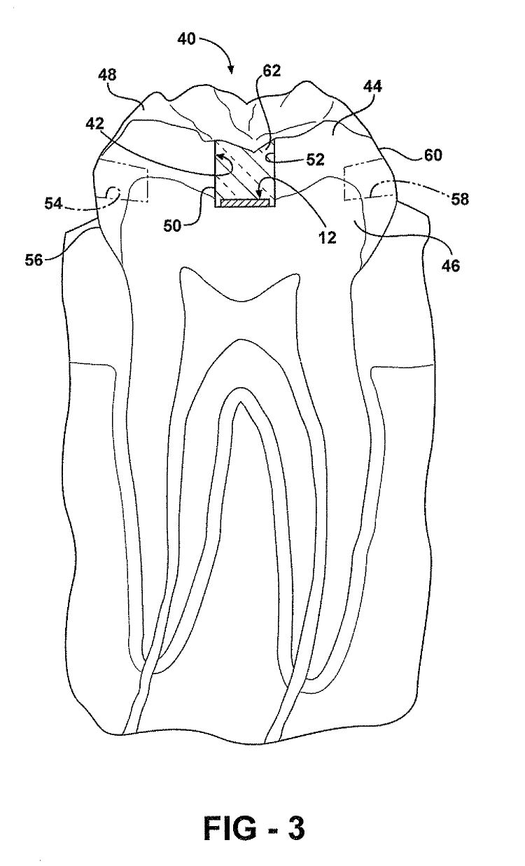

Referring now to FIG. 3, there is depicted a mounting location for the tag 12 in the tooth 40 of a person 10.

Tooth, as used herein, will be understood to include a lying or remainder of a tooth formed, typically after a root canal, which receives a crown, preexisting in the oral cavity of a person or fixed within the oral cavity by a dental procedure,

An open ended cavity 42 is formed in the tooth 40, shown by way of example only in FIG. 3 as extending from the occusal or bight surface of the tooth 40 into a bottom wall 50 in the enamel portion 44 of the tooth 40. The cavity 42 may also extend to a bottom wall 50 which is located in the dentin portion 46 of the tooth 40. By way of example only, the bottom wall or end wall 50 of the cavity 42 may extend approximately one millimeter into the dentin portion 46 of the tooth 40.

The shape and size of the cross section of the cavity 42 formed by a sidewall 52 is selected to enable easy placement of the tag 50 through the open end of the cavity 42 and into a resting relationship with the bottom wall 50 of the cavity 42. Alternately, the cross section of the cavity 42 may be formed to first remove all decay when the tag mounting operation is combined with a decay removal and tooth filling dental procedure.

The tag 12 is disposed in the cavity 42 in a position for clear communication by the antenna 26 with the communication links 30 and 32.

FIG. 3 also depicts alternate mounting positions of a cavity 54 extending inward from the lingual surface 56 of the tooth 40 where a cavity 58 extending inward from the buccal surface of the tooth 40.

For example only, the cavity 42 may be about four to about five millimeters deep. There should be at least about one or two millimeters thick of cavity filling material between the tag 12 and the surface of the cavity for the tag 12 could be formed in the tooth formed after a root canal, and beneath the crown itself.

According to the present method, the cavity 42 is formed according to established dental procedures. The tag 12 is then mounted in the cavity 42 in a position to establish clear communication by the antenna 26 with the communication links 30 and 32. A dental filling material, such a composite resin or amalgam, is gently packed in the cavity 42 filling the cavity 42 up to the occusal surface 48 of the tooth 40. The filling material 62, when cured to a solidified or hardened state, securely affixes the position of the tag 40 within the cavity 42 and prevents movement and inhibits removal of the tag 12 from the cavity 42.

At the same time, if it becomes necessary to replace the tag 12 due to malfunction, upgrades, etc., the filling material 62 can be removed from the cavity 42 to enable removal of the tag 12 from the cavity 42.

What is claimed is:

1. A method for remotely monitoring the location of a person comprising the steps of:
preparing a cavity in a tooth of a person;
mounting a microchip in the cavity, the microchip including a transceiver means for transmitting a wireless signal containing geographic location information relating to the physical location of the person, the microchip adapted for communicating with a Global Positioning System to receive geographic location information of the person;
filling the cavity with a dental filling material;
establishing communication between the microchip by a first communication link and a tracking apparatus which wirelessly communicates with the microchip to obtain the geographic location information from the microchip to determine the geographic location of the person; and
establishing communication between the microchip by a second communication link between the microchip and the Global Positioning System for obtaining geographic information relating to the physical location of the person.

2. The method of claim 1 further comprising:
forming the cavity extending into the enamel of the tooth.

3. The method of claim 1 further comprising the step of:
forming a cavity extending through the enamel and into the dentin portion of the tooth.

4. The method of claim 1 further comprising the step of:
forming the cavity to extend from the occusal surface of the tooth.

5. The method of claim 1 further comprising the step of:
forming the cavity to extend from one of the lingual and the buccal surface of a tooth.

6. The method of claim 1 further comprising the step of:
adding the filling material to the cavity to form a layer of filling material between the surface of the tooth and the microchip of at least one millimeter.

7. A system for remotely monitoring the location of a person comprising:
preparing a cavity in a tooth of a person;
mounting a microchip in the cavity, the microchip including a transceiver means for transmitting a wireless signal containing geographic location information relating to the physical location of the person, the microchip adapted for communicating with a Global Positioning System to receive geographic location information of the person;
filling the cavity with a dental filling material;
establishing communication between the microchip by a first communication link and a tracking apparatus which wirelessly communicates with the microchip to obtain the geographic location information from the microchip to determine the geographic location of the person; and
establishing communication between the microchip by a second communication link between the microchip and the Global Positioning System for obtaining geographic information relating to the physical location of the person.

8. A system for remotely monitoring the location of a person comprising:
a microchip including a transceiver for transmitting a wireless signal containing geographic information relating to the physical location of a person, the microchip adapted to be mounted in a tooth of a person;
a Global Positioning System transmitting global positioning data to the microchip; and
a tracking apparatus disposed of a wireless communication with a microchip to obtain the geographic information from the microchip to determine the physical location of the person.

9. The system of claim 8 further comprising:
the microchip disposed in an open-ended cavity formed in a tooth of a person; and
a dental filling material disposed in the cavity to fill the cavity up to the exterior surface of the tooth.

10. The system of claim 8 wherein:
the cavity extends into the enamel portion of a tooth.

11. The system of claim 8 wherein:
the cavity extends through the enamel portion and into the dentin portion of a tooth.

12. The system of claim 8 wherein:
the cavity extends from an occusal surface of a tooth.

13. The system of claim 8 wherein:
the cavity extends from one of a lingual surface and a buccal surface of a tooth.

14. The system of claim 1 wherein:
the filling material forms a layer of at least one millimeter thick between the microchip and an exterior surface of the tooth.
